(19) United States
(12) Patent Application Publication
(10) Pub. No.: US 2010/0208346 A1
(43) Pub. Date: Aug. 19, 2010

(54) Multilayer Dielectric Transmission Gratings Having Maximal Transmitted Diffraction Efficiency

(76) Inventor: Jerald A. Britten, Clayton, CA (US)

Correspondence Address: LLNS / John P. Wooldridge;John H. Lee, Assistant Laboratory Counsel, L-703, P.O Box 808, Livermore, CA, 94551, US

(21) Appl. No.: 12/371,451

(22) Filed: Feb. 13, 2009

(51) Int. Cl. G02B 5/18; B32B 37/00; B29D 11/00

(52) U.S. Cl. 359/576; 156/60; 216/24

(57) ABSTRACT

A multilayer dielectric transmission grating is made by coating a substrate with an antireflective (AR) coating and placing a dielectric grating on the AR coating. This grating is designed to transmit the maximum amount of light transmitted through the optic into the −1 order. Both the grating and the AR coating are designed to user specifications based on the desired incidence angle and wavelength range. The AR coating and grating act in concert to maximize the transmitted diffraction efficiency.

The United States Government has rights in this invention pursuant to Contract No. DE-AC52-07NA27344 between the United States Department of Energy and Lawrence Livermore National Security, LLC.

### BACKGROUND OF THE INVENTION

1. Field of the Invention

The present invention relates to gratings, and more specifically, it relates to dielectric transmission gratings.

2. Description of Related Art

Surface-relief transmission gratings are used in a wide variety of applications. As examples, they are used in beam steering optics in high power laser systems, as pulse compression optics for short-pulse laser systems, and as frequency dispersing elements in spectrometers and telecommunications devices. Surface-relief transmission gratings up to the present are manufactured by engraving a grating structure into a single polymeric material atop a transparent substrate, or by transfer etching a grating pattern into the transparent substrate. The height and width of the grating structures for a given grating period are adjusted to give an optimum transmission efficiency for a central use wavelength and incidence angle. Such gratings typically have diffraction efficiencies in the low to mid 90%. In almost all of the applications outlined above, the maximum possible diffraction efficiency over a given wavelength range is desired. Also, the optimum grating design requires grating grooves that are very deep compared with their period. This makes them challenging to fabricate. A multilayer dielectric transmission grating is desired that produces transmitted diffraction efficiencies in the mid to upper 90%. Methods for fabricating multilayer dielectric transmission gratings are also desired.

### SUMMARY OF THE INVENTION

It is an object of the present invention to provide multilayer dielectric transmission gratings that produce transmitted diffraction efficiencies in the mid to upper 90%.

Another object is to provide a method for fabricating multilayer dielectric transmission gratings.

These and other objects will be apparent based on the disclosure herein.

Embodiments of the invention include a substrate on which is coated one or more layers of dielectric material that create an antireflective (AR) property for a designed wavelength and incidence angle. Atop this AR structure is a diffraction grating structure made of one or more dielectric materials, which may or may not be part of the original AR layer(s). Such a multilayer dielectric transmission grating can be made to have a higher transmitted diffraction efficiency at a lower overall grating depth than a transmission grating made by etching a grating into the bulk substrate or depositing a single grating layer atop the substrate.

Embodiments of the present transmission gratings can be used a wide variety of applications including high-power laser optics, telecommunications, astronomy and spectroscopy.

### BRIEF DESCRIPTION OF THE DRAWINGS

The accompanying drawings, which are incorporated into and form a part of the disclosure, illustrate embodiments of the invention and, together with the description, serve to explain the principles of the invention.

FIG. 1 shows a multilayer dielectric transmission grating according to an embodiment of the present invention.

FIG. 2A shows transmitted diffraction efficiency as a function of grating depth and duty cycle for a grating etched into bulk fused silica.

FIG. 2B shows transmitted diffraction efficiency as a function of grating depth and duty cycle for a grating etched into a SiO₂ layer placed atop a 2-layer AR coating.

FIG. 3A shows transmitted diffraction efficiency as a function of grating depth and duty cycle for a photoresist grating atop bulk fused silica. 1780 l/mm, 633 nm light incident at S polarization at 34°.

FIG. 3B shows transmitted diffraction efficiency as a function of grating depth and duty cycle for a photoresist grating atop 4-layer AR coating.

FIG. 4A shows transmitted diffraction efficiency as a function of grating depth and duty cycle for a grating etched into bulk fused silica.

FIG. 4B shows transmitted diffraction efficiency as a function of grating depth and duty cycle for a grating etched into SiO₂ layer atop 2-layer AR coating on fused silica.

FIG. 5A shows transmitted diffraction efficiency as a function of grating depth and duty cycle for a photoresist grating atop bulk fused silica.

FIG. 5B shows transmitted diffraction efficiency as a function of grating depth and duty cycle for a photoresist grating atop 4-layer AR coating.

FIGS. 6A-6F illustrate a manufacturing process for an embodiment of the present invention.

FIGS. 7A-7D illustrate a manufacturing process for an embodiment of the present invention.

### DETAILED DESCRIPTION OF THE INVENTION

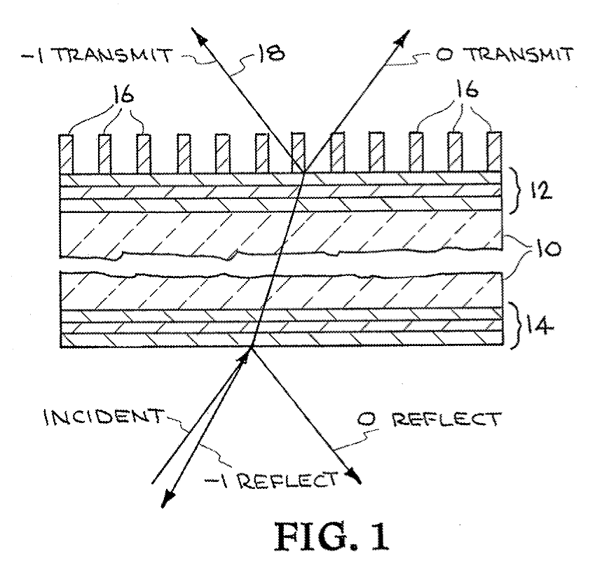

FIG. 1 shows an embodiment of the present multilayer dielectric transmission grating. A substrate 10 has been coated with a 3-layer antireflective (AR) coating (12, 14) on both sides. (Embodiments of the present invention include an AR coating on only one side.) The 3-layer AR coatings are designed such that the partial reflections from each of the interfaces between layers of the AR coating, as well as the interface between the AR coating and the substrate, interfere destructively and cancel out the overall reflection. More or fewer layers can be employed to the same effect. A dielectric grating 16 is placed on top of one of these AR multilayers. This grating is designed to direct the maximum amount of light transmitted through the optic into the −1 order (illustrated as ray 18). Both the grating and the AR multilayers are designed to user specifications based on the desired incidence angle and wavelength range. The AR stack and grating act in concert to maximize the transmitted diffraction efficiency.

In addition to designing the AR stack to be effective at the use angle and wavelength required of the grating, it can also be designed to be antireflective at the exposure wavelength of the grating during grating manufacture. Generally, a transmission grating would have its other surface coated with an AR coating in any case, so the addition of an AR coating on the grating surface is not of significant additional expense. The same AR coating design can be used for both surfaces. The grating layer can be etched into a dielectric material deposited as part of the AR layers, or it can be applied after the fact.

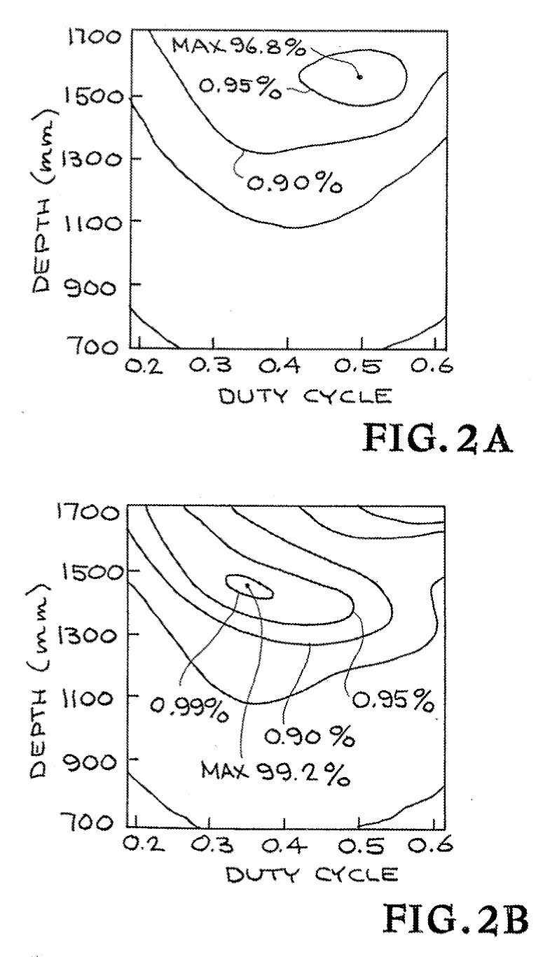

FIGS. 2A and 2B provide a comparison of the theoretical transmitted diffracted efficiency as a function of grating depth and duty cycle (linewidth to period ratio) for a grating etched into bulk fused silica and one etched into a SiO2 layer atop a 2-layer AR structure consisting of 235 nm of Ta₂O₅ and 171 nm MgF₂. Both gratings are 1333 lines/mm, designed for 1064 nm light at S polarization, incident at 45 degrees. The maximum efficiency for the grating structure of FIG. 2A is 96.8% at a groove depth of 1580 nm. The maximum efficiency of the grating structure of FIG. 2B is 99.2% at a depth of 1430 nm.

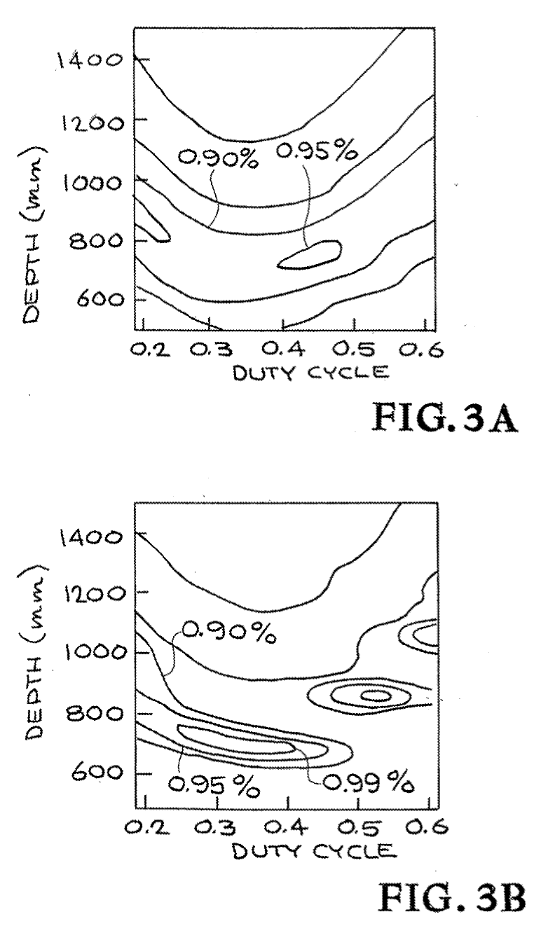

FIGS. 3A and 3B enable a comparison of the theoretical transmitted diffracted efficiency as a function of grating depth and duty cycle for a photoresist grating atop a fused silica substrate and atop a 4-layer AR structure consisting of ZrO₂ and MgF₂. Both gratings are 1870 lines/mm, designed for 632 nm light at TE polarization, incident at 34 degrees. The maximum efficiency for the grating structure of FIG. 3A is 94.0% at a groove depth of ˜1300 nm. The efficiency of the MLD grating of FIG. 3B is 99.7% at a depth of ˜1200 nm.

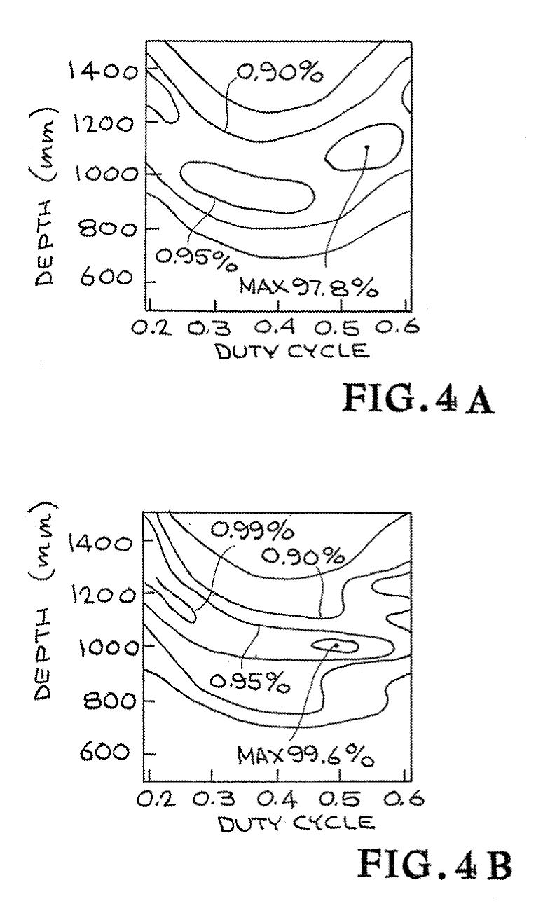

FIGS. 4A and 4B provide a comparison of the theoretical transmitted diffracted efficiency of 632 nm light at TE polarization incident at 34 degrees onto a 1780 line/mm grating as a function of grating depth and duty cycle (linewidth to period ratio) for a grating etched into bulk fused silica and one etched into a 1010 nm SiO2 layer atop a 2-layer AR structure consisting of 132 nm of ZrO2 and 85 nm MgF₂. The maximum efficiency for the grating structure of FIG. 4A is 97.8% at a groove depth of ˜1100 nm. The maximum efficiency of the MLD grating of FIG. 4B is 99.6% at a depth of ˜1050 nm.

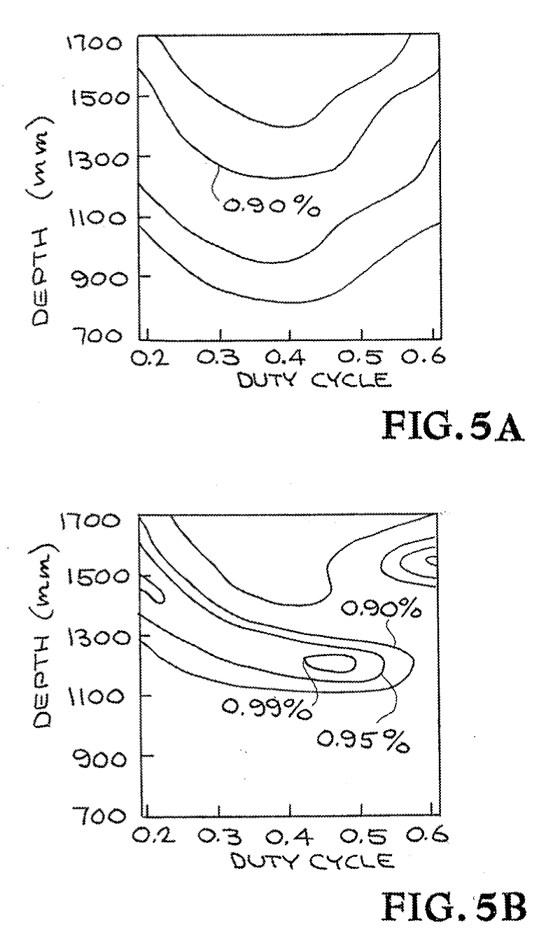

FIGS. 5A and 5B enable a comparison of the theoretical transmitted diffracted efficiency as a function of grating depth and duty cycle for a photoresist grating atop a fused silica substrate and atop a 4-layer AR structure consisting of ZrO₂ and MgF₂. Both gratings are 1333 lines/mm, designed for 1064 nm light at TE polarization, incident at 45 degrees. The maximum efficiency for the grating structure of FIG. 5A is 94.0% at a groove depth of ˜1300 nm. The efficiency of the MLD grating of FIG. 5B is 99.7% at a depth of ˜1200 nm.

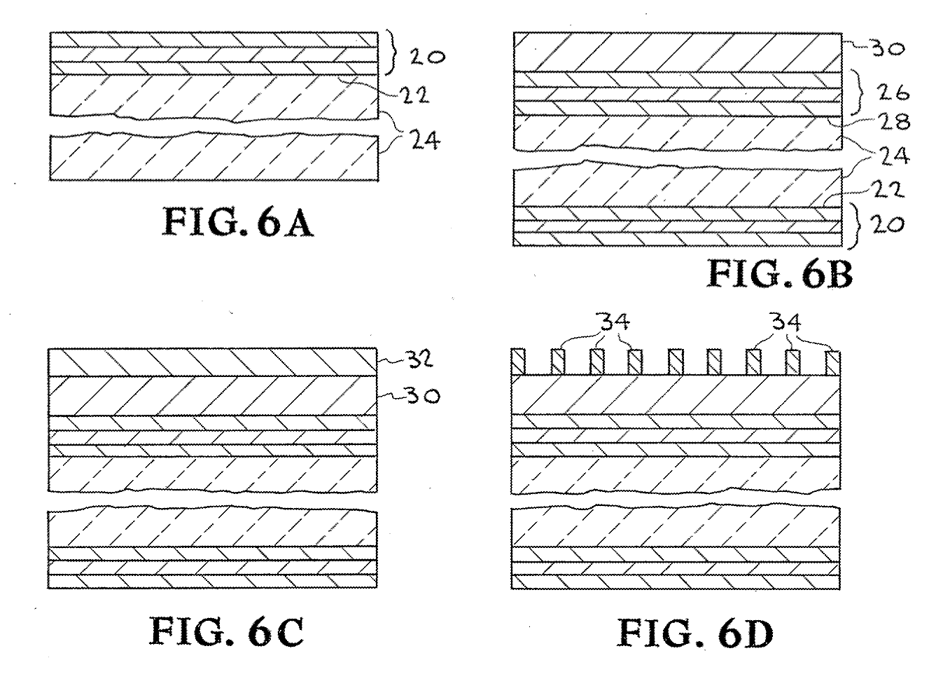

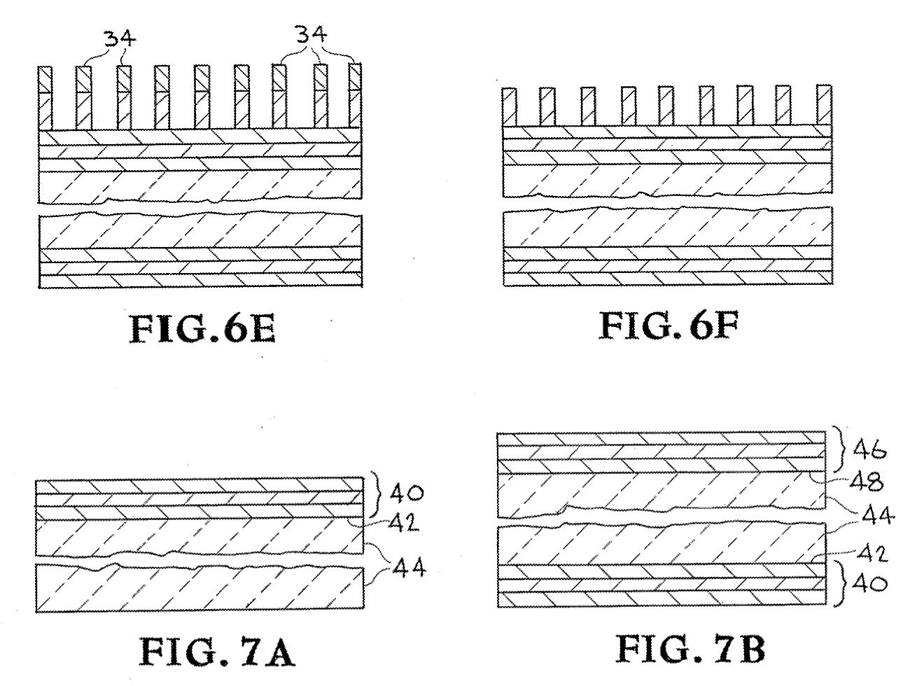

FIGS. 6A-6F show a step-by-step manufacturing process for one embodiment of the present invention. FIG. 6A shows a three layer AR coating 20 deposited on surface 22 of a transmissive substrate 24 (the surface opposite to that the grating is to be made). A three-layer AR coating is depicted in this embodiment, but other embodiments are not limited to this number of layers. The coating is designed to be antireflective at use angle and wavelength. It can also be designed to be antireflective at angle and wavelength conditions under which the photoresist pattern is exposed. Other functionalities can be designed into this coating as well.

FIG. 6B shows a second AR coating 26 deposited onto surface 28 of transmissive substrate 24. FIG. 6B also shows an additional layer 30 deposited onto AR coating 26. Layer 30 will be made into a grating layer. The second AR coating 26 is designed to give optimal diffraction efficiency in transmission at use wavelength and angle. Other functionalities can be designed into this stack. One grating layer is depicted, but other embodiments are not limited to a single grating layer.

FIG. 6C shows a photoresist layer 32 that has been deposited onto layer 30. The photoresist layer can be applied by a number of methods including, but not limited to, spin coating, meniscus coating and dry film evaporation. Also, one or more underlying absorbing layers (not shown) can be applied as necessary for manufacturing ease, to be removed by subsequent processing.

FIG. 6D shows a surface relief grating structure 34 that has been made in photoresist layer 32 by standard processing techniques including, but not limited to, laser interference lithography (holography), e-beam writing and exposure through masks.

FIG. 6E shows transfer etching of a structure into additional layer 30 by means including, but not limited to, ion beam etching, reactive plasma etching and wet chemical etching. The structure that has been transfer etched matches the period of surface relief grating structure 34.

FIG. 6F shows the final grating made by removal of the photoresist mask by means including, but not limited to, wet chemical stripping and dry chemical stripping.

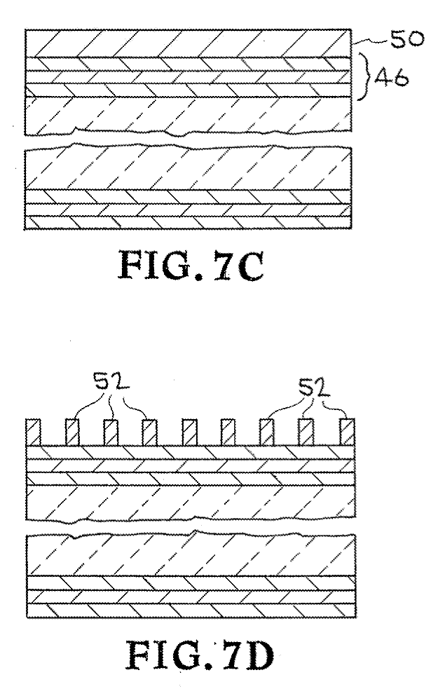

An alternate fabrication method is shown in FIGS. 7A-7D. FIG. 7A shows the deposition of a three layer AR film 40 on the surface 42 of substrate 44. Surface 42 is opposite to that where the grating structure is to be applied, in a manner analogous to that of FIG. 6A. FIG. 7B shows an AR film 46 deposited on surface 48 of substrate 44. The grating structure will be applied onto AR film 46. This AR film (46) is designed to work with the final grating structure to provide maximal diffraction efficiency at use conditions. FIG. 7C shows a photoresist film 50 that has been deposited in a manner similar to that as described in FIG. 6C. FIG. 7D shows the patterned grating 52 that has been formed in the photoresist film analogous to that of FIG. 7D. In this case, the configuration of the optical device in FIG. 7D is the final product, and the photoresist film height and duty cycle have been optimized for maximum diffraction efficiency in transmission under use conditions.

The foregoing description of the invention has been presented for purposes of illustration and description and is not intended to be exhaustive or to limit the invention to the precise form disclosed. Many modifications and variations are possible in light of the above teaching. The embodiments disclosed were meant only to explain the principles of the invention and its practical application to thereby enable others skilled in the art to best use the invention in various embodiments and with various modifications suited to the particular use contemplated. The scope of the invention is to be defined by the following claims.

I claim:

1. A multilayer dielectric transmission grating, comprising:
a substrate comprising a first side and a second side;
a first antireflection (AR) coating comprising an AR coating first side and an AR coating second side, wherein said AR coating first side is operatively attached to said substrate second side; and
a diffraction grating operatively attached to said AR coating second side, wherein said diffraction grating comprising one or more dielectric materials.

2. The grating of claim 1, further comprising a second AR coating, wherein said second AR coating comprises a second AR coating first side and a second AR coating second side, wherein said second AR coating second side is operatively attached to said substrate first side.

3. The grating of claim 1, wherein said first AR coating comprises 3 layers.

4. The grating of claim 2, wherein said second AR coating comprises 3 layers.

5. The grating of claim 1, wherein said grating is designed to transmit light into the −1 order.

6. The grating of claim 1, wherein said AR coating is designed to be effective at a desired use angle and wavelength.

7. The grating of claim 1, wherein said AR coating is designed to be antireflective at the exposure wavelength of said grating during grating manufacture.

8. The grating of claim 1, wherein said grating is part of said AR coating.

9. The grating of claim 1, wherein said grating is etched into said AR coating.

10. The grating of claim 1, wherein said grating is affixed atop said AR coating second side.

11. A method for making a multilayer dielectric transmission grating, comprising:
providing a substrate comprising a first side and a second side;
providing a first antireflection (AR) coating comprising an AR coating first side and an AR coating second side;
operatively attaching said AR coating first side to said substrate second side; and
operatively attaching a diffraction grating to said AR coating second side, wherein said diffraction grating comprising one or more dielectric materials.

12. The method of claim 11, further comprising:
providing a second AR coating comprising a second AR coating first side and a second AR coating second side; and
operatively attaching said second AR coating second side to said substrate first side.

13. The method of claim 11, wherein said first AR coating comprises 3 layers.

14. The method of claim 12, wherein said second AR coating comprises 3 layers.

15. The method of claim 11, wherein said grating is designed to transmit light into the −1 order.

16. The method of claim 11, wherein said AR coating is designed to be effective at a desired use angle and wavelength.

17. The method of claim 11, wherein said AR coating is designed to be antireflective at the exposure wavelength of said grating during grating manufacture.

18. The method of claim 11, wherein said grating is part of said AR coating.

19. The method of claim 11, wherein said grating is etched into said AR coating.

20. The method of claim 11, wherein said grating is affixed atop said AR coating second side.
